(19) United States
(12) Patent Application Publication
(10) Pub. No.: US 2023/0341122 A1
(43) Pub. Date: Oct. 26, 2023

(54) LIGHTING ASSEMBLY HAVING AN INTEGRATED COFFEE/TEA HEATER

(71) Applicant: Lee Schaak, Dix Hills, NY (US)

(72) Inventor: Lee Schaak, Dix Hills, NY (US)

(21) Appl. No.: 17/945,269

(22) Filed: Sep. 15, 2022

Related U.S. Application Data
(60) Provisional application No. 63/333,244, filed on Apr. 21, 2022.

(51) Int. Cl. F21V 33/00; A47J 36/24; F21S 6/00

(52) U.S. Cl. CPC F21V 33/0044; A47J 36/2483; F21S 6/003; F21S 6/005

(57) ABSTRACT

A lighting assembly, including: (a) a frame sub-assembly; and (b) an electronics sub-assembly, wherein the electronics sub-assembly includes at least one light, and at least one heating element associated with the frame sub-assembly.

### CROSS-REFERENCE TO RELATED APPLICATIONS

This application claims the benefit of U.S. Provisional Application Ser. No. 63/333,244 entitled “LIGHTING ASSEMBLY HAVING AN INTEGRATED COFFEE/TEA HEATER,” filed Apr. 21, 2022—which is hereby incorporated herein by reference in its entirety, including all references cited therein.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to lighting assemblies, and, more particularly, to lighting assemblies that include an integrated coffee/tea heater. The lighting assemblies of the present invention include, but are not limited to, floor lamps, table lamps, desk lamps, and task lamps, that comprise one or more heating elements which are adapted to heat coffee/tea cups, mugs, and glasses to a plurality of predetermined temperatures. Certain embodiments of the present invention include safety sensors associated with the lighting assemblies to prevent overheating and/or fire hazards.

### 2. Background Art

Lighting assemblies have been known in the art for years and are the subject of a plurality of patents and publications, including: U.S. Pat. No. 10,161,605 entitled “Lighting Assembly,” U.S. Pat. No. 9,759,391 entitled “LED Light Fixture Assembly,” U.S. Pat. No. 8,956,013 entitled “LED Light Troffer/Fixture Assembly,” U.S. Pat. No. 8,628,209 entitled “Light Assembly,” U.S. Pat. No. 7,847,486 entitled “LED Lighting System,” U.S. Pat. No. 6,979,097 entitled “Modular Ambient Lighting System,” United States Patent Application Publication Number 2013/0099698 entitled “Lighting Device,” United States Patent Application Publication Number 2013/0033195 entitled “Light Source Apparatus,” United States Patent Application Publication Number 2011/0163672 entitled “Light Assembly,” and Spanish Patent Application Publication Number 2,796,563 entitled “Lighting Device”—all of which are hereby incorporated herein by reference in their entirety including all references cited therein.

U.S. Pat. No. 10,161,605 appears to disclose an elongate tubular lighting assembly having a body with a length between spaced first and second ends. The tubular lighting assembly has a source of illumination and first and second connectors respectively at the first and second body ends. The first connector has cooperating first and second parts having first and second surfaces. The first and second connector parts are configured so that the first and second surfaces are placed in confronting relationship to prevent separation of the first and second connector parts with the body in an operative state as an incident of the first connector part moving relative to the second connector part from a position fully separated from the second connector part in a substantially straight path that is transverse to the length of the body into an engaged position.

U.S. Pat. No. 9,759,391 appears to disclose a light assembly that contains a housing. One or more LED light units are contained within the housing, wherein each of the LED light units may contain only one corresponding conductive end cap. A pair of conductors extending from each of the corresponding conductive end caps are mated with a corresponding socket contained within a DC power supply module contained within the housing.

U.S. Pat. No. 8,956,013 appears to disclose a light assembly that contains a troffer having a housing. One or more LED light units are contained within the troffer, wherein each one of the LED light units contains only one corresponding conductive end cap. A pair of conductors extending from each of the corresponding conductive end caps are mated with a corresponding socket contained within a DC power supply module contained within the troffer.

U.S. Pat. No. 8,628,209 appears to disclose a light assembly that includes a housing containing at least one solid-state lighting device. The solid-state lighting device electrically communicates with an AC energy source in a known manner. At least one photovoltaic cell is connected to an inner wall of the housing adjacent to the solid-state lighting device whereby the photovoltaic cell absorbs radiative energy from the solid-state lighting device. At least one battery pack derives energy from the artificial light of the lighting device, by and through the photovoltaic cell. One or more LED lights, or an LED array, are contained within the housing, and electronically communicate with the battery pack. An actuation sensor activates a switching means to energize the LED light(s) with DC power from the battery pack.

U.S. Pat. No. 7,847,486 appears to disclose a lighting system that has an array of at least one light-emitting solid-state element such as a light-emitting diode (LED) or a laser diode. A voltage source, which may supply either alternating or direct current, energizes the array. Array state circuitry, electrically connected in series with the array, senses at least one state of the array, such as the amount of current passing through the array, or temperature. Secondary circuitry is connected in parallel with the array. A switching component that adjusts the current passing through the secondary circuitry in accordance with the sensed state of the array such that current through the array is maintained substantially constant. A third, parallel, excess current shunt path may also be provided, in which case so is excess current shunt circuitry, which senses current flowing in the secondary circuitry and shunts current in the secondary circuitry in excess of an excess current threshold to the excess current shunt path, whereby overflow current above a first threshold for the array is shunted away from the array and excess current above a second threshold is shunted from the secondary circuits to the excess current shunt circuitry. A wide-angle mounting arrangement is also provided for the array.

U.S. Pat. No. 6,979,097 appears to disclose a modular ambient lighting system for providing lighting to the interior of a building. The system features three separate modules: (1) a support module, (2) a power module, and (3) a light fixture body module. The support module provides an electrical connection to the building and structural connection to the ceiling of the building. An interchangeable power module fits into a recess or “foot print” in the support module. The power module includes the electrical components of the lighting system (e.g., ballast, transformer, emergency batteries, etcetera). An interchangeable light fixture body module houses the lamp that can be configured to deliver direct, indirect, or direct/indirect illumination. The interchangeable features of the modules offer superior flexibility because of the ease to reconfigure the electrical operation of the light system, the type illumination delivered, or the aesthetics of the light system.

United States Patent Application Publication Number 2013/0099698 appears to disclose a light film apparatus having an illuminated graphics panel with at least two segments that can be individually powered. A controller manages a power which is delivered from a power supply to each of the segments, so that each of the segments is either powered on, powered off or powered to an intermediate level. With the independent control of power to the different segments, it is possible to create a three-dimensional appearance of a moving image from a generally two-dimensional panel arrangement. A housing can be mounted so that the graphics panel abuts or is closely mounted to a mounting surface.

United States Patent Application Publication Number 2013/0033195 appears to disclose a light source apparatus that includes at least a light-emitting module. The light-emitting module includes a hollow rod-shaped base and a plurality of LED chips. The hollow rod-shaped base has an outer surface and an inner surface opposite to the outer surface, in which the inner surface surrounds a space. The LED chips are disposed in flip chip bonding way on the outer surface of the hollow rod-shaped base, in which the LED chips are disposed surrounding the space.

United States Patent Application Publication Number 2011/0163672 appears to disclose an LED lighting assembly containing: a housing; one or more solid state lighting units contained within the housing and actuated by alternating current power; a night light contained within the housing and operably communicating with the solid state lighting units, the night light actuated by direct current power in the absence of light from the solid state lighting units; one or more light emitting diodes contained within the night light; and a battery source for powering the night light in the event of power interruption. The '672 reference appears to further disclose a lighting unit containing: a housing or elongated tube; one or more light emitting diodes contained within the housing or elongated tube; and a battery source contained within the housing or elongated tube, the battery source is configured to selectively power the light emitting diodes with direct current energy.

Spanish Patent Application Publication Number 2,796,563 appears to disclose an illumination device comprising a housing, a base, a solid-state light source, and an optical means, wherein the solid-state light source is optically coupled to the optical medium, where the optical medium is an element within the lighting device separate from and not integrated in the envelope, where the optical medium is provided with a light decoupling surface that allows the light to be decoupled from the optical medium by means of a roughness of the optical medium surface, characterized in that the optical medium comprises an optical fiber, where the surface roughness is provided along the fiber so that the emission along the fiber resembles the emission from a carbon filament lamp.

While the above-identified patents and publications do appear to disclose various lighting assemblies, their configurations remain non-desirous and/or problematic inasmuch as, among other things, none of the above-identified lighting assemblies include one or more integrated heating elements that are adapted to heat coffee/tea cups, mugs, and glasses to a plurality of predetermined temperatures. Moreover, the above-identified references appear to be void of any safety sensors associated with the lighting assemblies to prevent overheating and/or fire hazards.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a lighting assembly, comprising, consisting essentially of and/or consisting of: (a) a frame sub-assembly; and (b) an electronics sub-assembly, wherein the electronics sub-assembly includes one or more lights, and one or more heating elements associated with the frame sub-assembly.

In a preferred embodiment of the present invention, the heating element is adapted to heat coffee/tea cups, mugs, and/or glasses to a plurality of predetermined temperatures.

In another preferred embodiment of the present invention, the heating element is positioned subjacent to any surrounding adjacent surfaces to help prevent both liquid spills and fires caused by unintended objects making contact with the heating element.

In yet another preferred embodiment of the present invention, the frame sub-assembly includes a floor lamp, a table lamp, a desk lamp and/or a task lamp.

In one preferred embodiment of the present invention, the frame sub-assembly includes a floor lamp having a plurality of generally upright legs, a lower shelf, and an upper shelf, wherein the heating element is associated with or forms part of the upper shelf.

In another preferred aspect of the present invention, the frame sub-assembly includes a floor lamp having a ground engaging base member, a lower support post, an upper extension post, and a side table positioned between the lower support post and the upper extension post, wherein the heating element is associated with or forms part of the side table.

In a preferred implementation of the present invention, the frame sub-assembly includes a table lamp having a base member, an extension post, and an articulating swing arm, wherein the heating element is associated with or forms part of the base member.

In another preferred implementation of the present invention, the frame sub-assembly includes a table lamp having a base member, and an extension post, wherein the heating element is associated with or forms part of the base member.

In yet another preferred implementation of the present invention, the frame sub-assembly includes a task lamp having a base member, an extension post, and a light housing, wherein the heating element is associated with or forms part of the base member.

In one preferred implementation of the present invention, the frame sub-assembly further includes a light/lamp shade.

In a preferred embodiment of the present invention, the frame sub-assembly includes a 110-volt AC outlet and/or a USB charging outlet.

In another preferred embodiment of the present invention, the frame sub-assembly includes a heat sensor, a smoke sensor, and/or a carbon monoxide sensor. In this embodiment, the frame sub-assembly preferably includes an audio output alarm that is triggerable by the heat sensor, the smoke sensor, and/or the carbon monoxide sensor.

In yet another preferred embodiment of the present invention, the heating element automatically shuts off when an alarm condition is sensed and an audio output alarm is triggered.

In one preferred embodiment of the present invention, the heating element includes a safety pressure sensor and/or a temperature sensor associated therewith.

In a preferred embodiment of the present invention, the heating element remains off unless the pressure sensor senses a coffee/tea cup, mug, and/or glass filled with a sufficient amount of fluid so as to prevent over heating of the coffee/tea cup, mug, and/or glass and/or burning adjacent products and/or an innocent bystander.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a pair of perspective views of a floor lamp of the present invention with and without a coffee mug, wherein the lamp without the coffee mug is augmented with a fragmented enlarged view showing the heating element;

FIG. 2 of the drawings is a pair of perspective views of an alternative floor lamp of the present invention with and without a coffee mug, wherein the lamp without the coffee mug is augmented with a fragmented enlarged view showing the heating element;

FIG. 3 of the drawings is a pair of perspective views of a swingarm table lamp of the present invention with and without a coffee mug;

FIG. 4 of the drawings is a pair of perspective views of a downbridge table lamp of the present invention with and without a coffee mug;

FIG. 5 of the drawings is a pair of perspective views of an incandescent task lamp of the present invention with and without a coffee mug;

FIG. 6 of the drawings is a pair of perspective views of an LED task lamp of the present invention with and without a coffee mug;

FIG. 7 of the drawings is schematic representation of an electronics sub-assembly for use in accordance with the present invention; and

FIG. 8 of the drawings is schematic representation of an alternative electronics sub-assembly for use in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

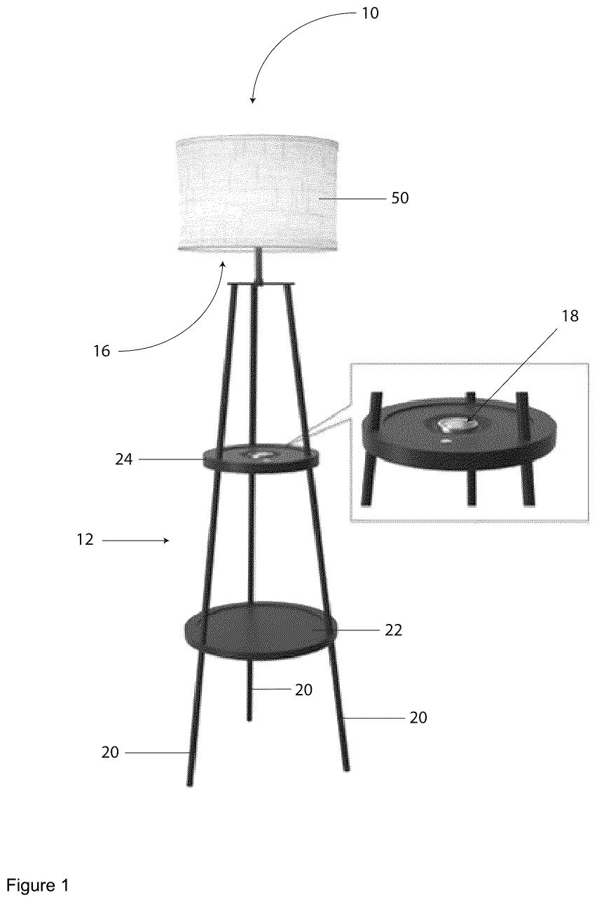

Referring now to the drawings, and collectively to FIGS. 1 and 7-8, lighting assembly 10 is shown as generally comprising frame sub-assembly 12 and electronics sub-assembly 14. Electronics sub-assembly 14 includes one or more lights 16 (i.e., lights or sockets therefor) and one or more heating elements 18 that are associated with, integrated into, and/or form part of frame sub-assembly 12. The heating element is adapted to heat coffee/tea cups, mugs, and/or glasses to a plurality of predetermined temperatures (e.g., 104° F., 131° F., 158° F.; an off position, a first on position (low heat), a second on position (medium heat) and a third on position (high heat), etcetera).

Preferably, heating element 18 is positioned subjacent to any surrounding adjacent surfaces to help prevent both liquid spills and fires caused by unintended objects making contact with the heating element. Such a configuration also makes it more difficult for an infant/toddler to accidently touch the heating element.

In accordance with the present invention, non-limiting examples of frame sub-assembly 12 include floor lamps, table lamps, desk lamps and/or task lamps.

As is best shown in FIG. 1, frame sub-assembly 12 may include a floor lamp comprising a plurality of generally upright or substantially vertical (e.g., more vertical than horizontal and/or greater than 45 degrees from the surface upon which the lighting assembly is placed) legs 20, lower shelf 22, and upper shelf 24. In this configuration, heating element 18 is associated with or forms part of upper shelf 24.

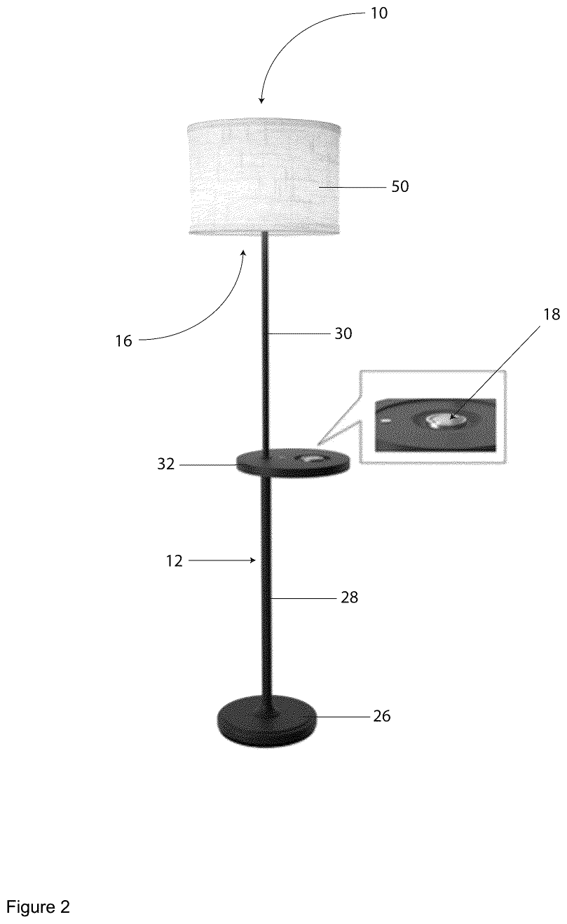

Referring now to FIG. 2, frame sub-assembly 12 may also include a floor lamp comprising ground engaging base member 26, lower support post 28, upper extension post 30, and side table 32 positioned between the lower support post and the upper extension post. In this configuration, heating element 18 is associated with or forms part of side table 32.

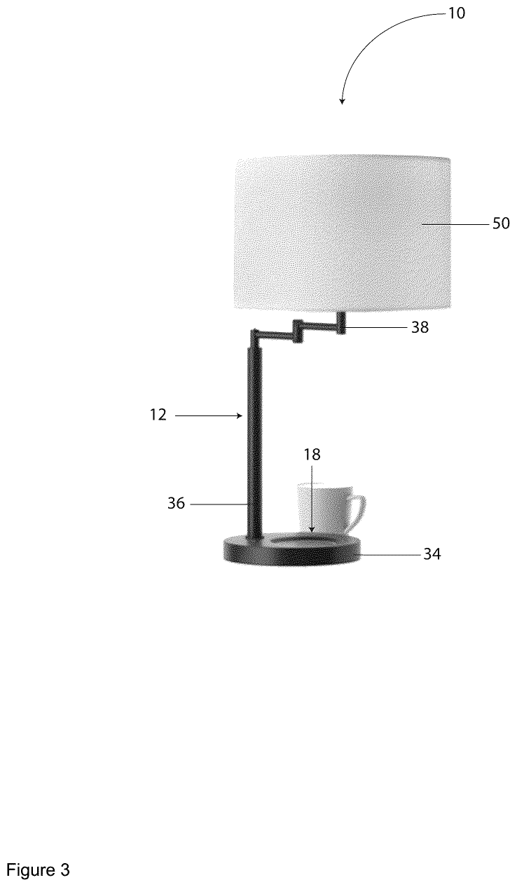

As is best shown in FIG. 3, frame sub-assembly 12 may further include a table lamp comprising base member 34, extension post 36, and articulating swing arm 38. In this configuration, heating element 18 is associated with or forms part of base member 34.

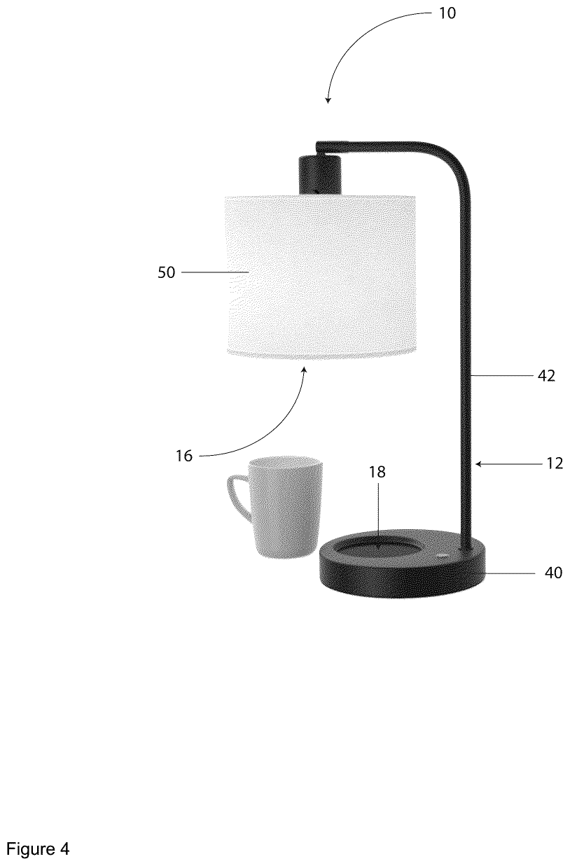

Referring now to FIG. 4, frame sub-assembly 12 may include a table lamp comprising base member 40, extension post 42. In this configuration, heating element 18 is associated with or forms part of base member 40. In this implementation, the coffee/tea cups, mugs, and glasses are heated using dual sources, namely heating element 18, as well as incandescent light 16. Notably, the socket holding light 16 is inverted such that the largest portion of the bulb is proximate the item being heated. This implementation provides for both direct (i.e., from heating element 18) and indirect (i.e., from light 16) heating of the item being heated.

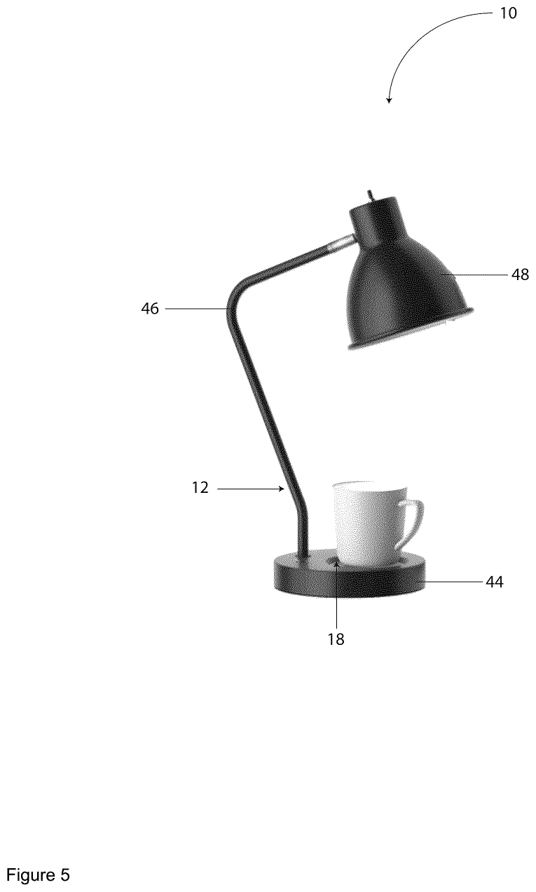

As is best shown in FIG. 5, frame sub-assembly 12 may also include a task lamp comprising base member 44, extension post 46, and light housing 48. In this configuration, heating element 18 is associated with or forms part of base member 44. This configuration also provides for dual heating and is especially efficient at dual heating because of the direction of the incandescent bulb, metal light housing 48 that has a high heat capacity, and the proximity of the bulb to the item being heated.

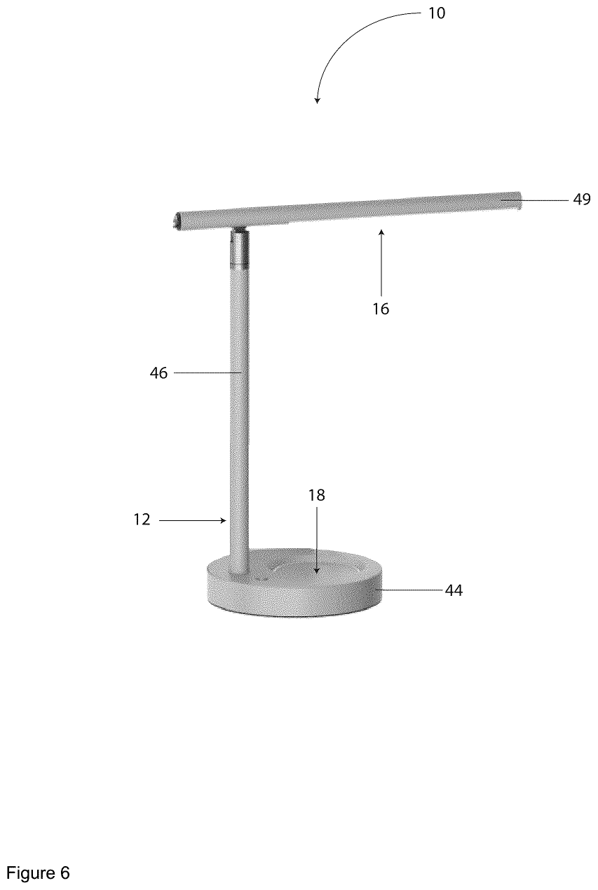

As is best shown in FIG. 6, frame sub-assembly 12 may also include a task lamp comprising base member 44, extension post 46, and swivel and pivoting LED light housing 49. In this configuration, heating element 18 is associated with or forms part of base member 44.

In many configurations of the present invention, light 16 is at least partially covered by light/lamp shade 50. It will be understood that the light shade is optional.

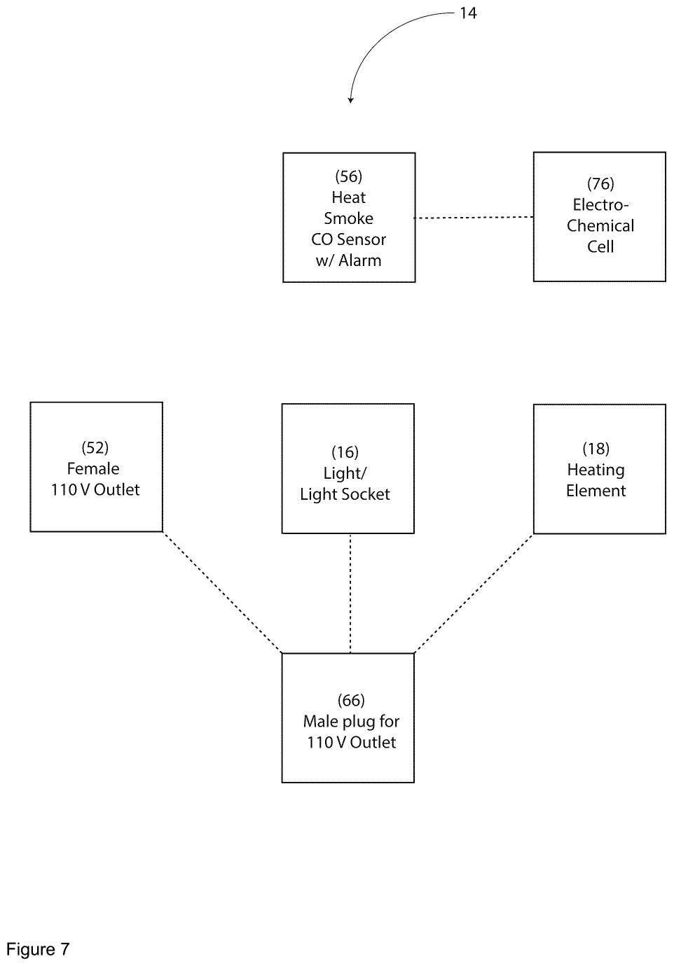

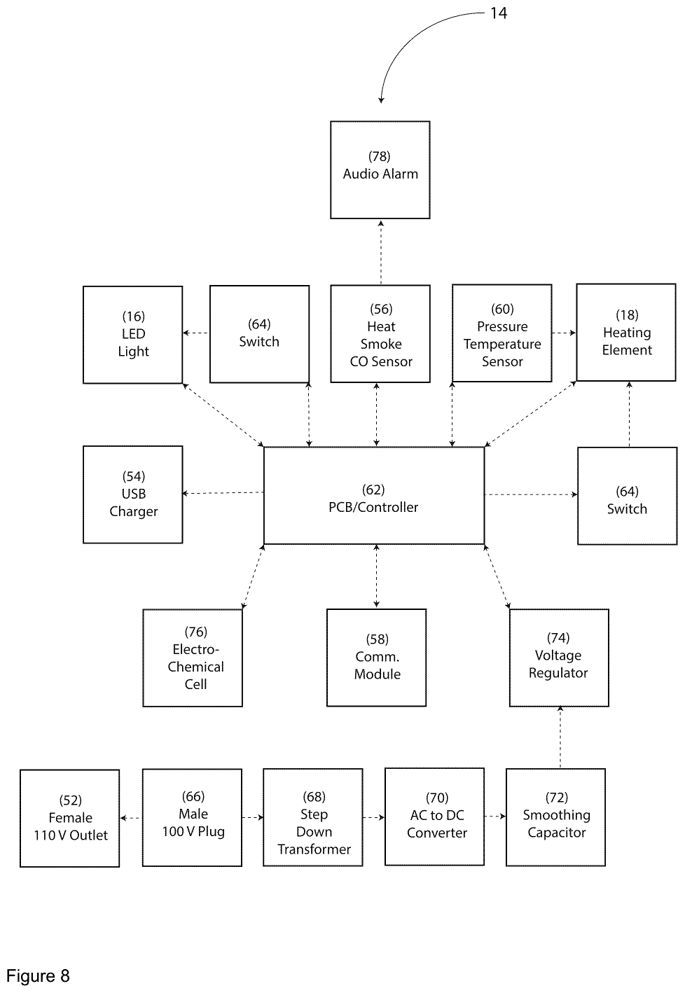

In one embodiment of the present invention, lighting assembly 10 includes 110-volt AC 52 (See FIGS. 7-8) outlet, which is preferably associated with, integrated into, and/or forms part of any component (e.g., base, shelf, side table, etcetera) of frame sub-assembly 12. Such an outlet allows for convenient use and/or charging of, for example, TVs, monitors, computers, tablets, phones, toaster ovens, toasters, vacuum cleaners, etcetera—without going being a desk or piece of furniture to reach the outlet.

In another embodiment of the present invention, lighting assembly includes USB charging port/outlet 54 (See FIG. 8), which is preferably associated with, integrated into, and/or forms part of any component (e.g., base, shelf, side table, etcetera) of frame sub-assembly 12. Again, such a port or outlet allows for convenient charging of, for example, phones and/or watches—without going being a desk or piece of furniture to reach the outlet.

In an attempt to minimize and/or prevent the real and present danger of a fire, lighting assembly 10 preferably includes heat sensor, smoke sensor, and/or carbon monoxide sensor 56 (See FIGS. 7-8), which is preferably associated with, integrated into, and/or forms part of any component (e.g., base, shelf, side table, light, lamp shade, post, etcetera) of frame sub-assembly 12. When triggered, such a sensor can sound audible alarm 78 and/or automatically turn off heating element 18 and/or light 16. Alternatively, when triggered, such a sensor can convert light 16 into a strobe light. Moreover, when triggered, such a sensor can communicate with communication module 58 to notify first responders or the homeowner of an emergency condition via pre-generated alert, text, email, and/or any other form of communication and/or notification.

Suitable examples of heat, smoke, and/or CO sensors include those commercially available from Gentex Corporation in Zeeland, Michigan, as well as those disclosed in U.S. Pat. No. 4,329,214 entitled “Gas Detection Unit,” U.S. Pat. No. 5,302,274 entitled “Electrochemical Gas Sensor Cells Using Three Dimensional Sensing Electrodes,” U.S. Pat. No. 5,331,310 entitled “Amperometric Carbon Monoxide Sensor Module for Residential Alarms,” U.S. Pat. No. 5,573,648 entitled “Gas Sensor Based on Protonic Conductive Membranes,” U.S. Pat. No. 5,618,493 entitled “Photon Absorbing Bioderived Organometallic Carbon Monoxide Sensors,” U.S. Pat. No. 5,650,054 entitled “Low Cost Room Temperature Electrochemical Carbon Monoxide and Toxic Gas Sensor with Humidity Compensation Based on Protonic Conductive Membranes,” U.S. Pat. No. 5,944,969 entitled “Electrochemical Sensor With A Non-Aqueous Electrolyte System,” U.S. Pat. No. 5,958,200 entitled “Electrochemical Gas Sensor,” U.S. Pat. No. 6,172,759 entitled “Target Gas Detection System with Rapidly Regenerating Optically Responding Sensors,” U.S. Pat. No. 6,200,443 entitled “Gas Sensor with a Diagnostic Device,” U.S. Pat. No. 6,936,147 entitled “Hybrid Film Type Sensor,” U.S. Pat. No. 6,948,352 entitled “Self-Calibrating Carbon Monoxide Detector and Method,” U.S. Pat. No. 7,077,938 entitled “Electrochemical Gas Sensor,” U.S. Pat. No. 7,022,213 entitled “Gas Sensor and Its Method of Manufacture,” U.S. Pat. No. 7,236,095 entitled “Solid State Sensor for Carbon Monoxide,” U.S. Pat. No. 7,279,081 entitled “Electrochemical Sensor,” U.S. Patent Publication No. 2005/0145494 entitled “Liquid Electrochemical Gas Sensor,” U.S. Patent Publication No. 2006/0091007 entitled “Gas Detecting Device with Self-Diagnosis for Electrochemical Gas Sensor,” U.S. Patent Publication No. 2006/0120924 entitled “Proton Conductor Gas Sensor,” and U.S. Patent Publication No. 2006/0196770 entitled “Liquid Electrochemical Gas Sensor,” all of which are hereby incorporated herein by reference in their entirety—including all references cited therein.

In another aspect of the present invention, lighting assembly 10 includes pressure and/or temperature sensor 60, which is preferably associated with, integrated into, and/or forms part of heating element 18. Such a sensor prevents heating element from turning on unless the sensor senses a coffee/tea cup, mug, and/or glass filled with a sufficient amount of fluid so as to prevent over heating of the coffee/tea cup, mug, and/or glass. The temperature sensor can automatically shut off heating element 18 if a predetermined, threshold or safety temperature is exceeded—even without triggering any other sensors, such as the CO sensor.

Light 16 is preferably an incandescent, florescent, and/or LED light. With reference to FIG. 8, if light 16 includes one or more LEDs, then the LEDs may be dimmable (i.e., intensity controlled via PCB/Controller 62 in cooperation with switch 64. The LEDs may also be color controlled (e.g., warm, cool, etcetera) in accordance with the teachings disclosed in U.S. Pat. No. 9,844,116 entitled “Systems and Methods for Controlling the Spectral Content of LED Lighting Devices” and U.S. Pat. No. 9,848,475 entitled “LED Light Source and Method for Adjusting Color Tone or Color Temperature of LED Light Source”—all of which are hereby incorporated herein by reference in their entirety including all references cited therein.

With further reference to FIG. 8, in a preferred embodiment of the present invention, lighting assembly 10 rectifies 110-230V AC current to clean, non-pulsed 12V DC using the following steps. First, male plug 66 receives 110-230V AC current via a conventional outlet. Second, stepdown transformer 68 lowers the input voltage from 110-230V AC to 12V AC. Third, AC/DC converter 70 converts the AC to DC current using a PN junction diode in a 4-diode configuration to provide for efficient full wave rectification. Fourth, the smoothing capacitor 72 converts the rippled or pulsating DC current to pure, non-pulsating DC current. This is important for the longevity of all DC components associated with electronics sub-assembly 14. Fifth, a 3-pin integrated circuit voltage regulator 74 regulates output to a predetermined voltage best applicable primary to PCB/Controller 62.

Lighting assembly 10 may also optionally include primary and/or secondary electrochemical cell 76. Electrochemical cell 76 may provide the sole source of any required DC current and/or augment the DC current output from voltage regulator 74. Notably, electrochemical cell 76 is isolated from conversion components 66-74 so that a failure of these components does not interfere with the DC operation of the lighting assembly.

In one embodiment, electrochemical cell 76 of lighting assembly 10 preferably comprises, a secondary electrochemical cell, such as a lead acid, NiCad, NiMH, and/or lithium-ion battery and/or fuel cell. Preferred examples of lithium-ion batteries include lithium cobalt oxide (LiCoO₂) batteries, lithium manganese oxide (LiMn₂O₄) batteries, lithium nickel manganese cobalt oxide (LiNiMnCoO₂) batteries, lithium iron phosphate (LiFePO) batteries, lithium nickel cobalt aluminum oxide (LiNiCoAlO₂) batteries, and lithium titanate (Li₄Ti₅O₁₂) batteries. In one embodiment, electrochemical cell 76 comprises a secondary electrochemical cell having an anode, a cathode, and an electrolyte, wherein at least one of the anode, cathode, and electrolyte are monitored by circuit board/controller 62, wherein variables pertaining to the structural integrity of the anode, the cathode, the electrolyte, a passivation layer associated with the anode and/or the cathode, and/or the cycle life of each component—including electrolyte level, are stored in a memory module. In this embodiment, the secondary electrochemical cell participates in reversible redox reactions. In addition, electrochemical cell 76 may be coupled with at least one of a fixed capacitor, a variable capacitor, and a polarized capacitor to regulate the storage of potential energy within lighting assembly 10.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A lighting assembly, comprising:
a frame sub-assembly, wherein the frame sub-assembly includes a base member having a top horizontal surface; and
an electronics sub-assembly, wherein the electronics sub-assembly includes at least one light, and a heating element, wherein the heating element is positioned within the base member, and wherein the heating element includes an annular surface that is positioned subjacent and parallel to the top horizontal surface of the base member.

2. The lighting assembly according to claim 1, wherein the heating element is adapted to heat coffee/tea cups, mugs, and/or glasses to a plurality of predetermined temperatures.

3. (canceled)

4. The lighting assembly according to claim 1, wherein the frame sub-assembly includes a floor lamp, a table lamp, a desk lamp and/or a task lamp.

5-9. (canceled)

10. The lighting assembly according to claim 1, wherein the frame sub-assembly further includes a light/lamp shade.

11. The lighting assembly according to claim 1, wherein the frame sub-assembly comprises a 110-volt AC outlet.

12. The lighting assembly according to claim 1, wherein the frame sub-assembly comprises a USB charging outlet.

13. The lighting assembly according to claim 1, wherein the frame sub-assembly comprises a heat sensor, a smoke sensor, and/or a carbon monoxide sensor.

14. The lighting assembly according to claim 13, wherein the frame sub-assembly includes an audio output alarm that is triggerable by the heat sensor, the smoke sensor, and/or the carbon monoxide sensor.

15. The lighting assembly according to claim 14, wherein the heating element automatically shuts off when the heat sensor, the smoke sensor, and/or the carbon monoxide sensor is triggered.

16. The lighting assembly according to claim 1, wherein the heating element includes a pressure and/or temperature sensor associated therewith.

17. The lighting assembly according to claim 16, wherein the at least one heating element remains off unless the pressure sensor senses a coffee/tea cup, mug, and/or glass filled with a sufficient amount of fluid so as to prevent over heating of the coffee/tea cup, mug, and/or glass.

18. The lighting assembly according to claim 17, wherein the heating element is positionable among an off position, a first on position, a second on position, and a third on position.

19. A lighting assembly, comprising:
a frame sub-assembly, wherein the frame sub-assembly includes a base member having a top horizontal surface; and
an electronics sub-assembly, wherein the electronics sub-assembly includes at least one light, and a heating element, wherein the heating element is positioned within the base member, and wherein the heating element includes an annular surface that is positioned subjacent and parallel to the top horizontal surface of the base member, and wherein the electronics sub-assembly includes a male plug that receives 110-230V AC current via a conventional outlet, a stepdown transformer that lowers the input voltage from 110-230V AC to 12V AC, an AC/DC converter that converts the AC to DC current using a PN junction diode in a 4-diode configuration to provide for full wave rectification, a smoothing capacitor that converts rippled or pulsating DC current to pure, non-pulsating DC current, and a 3-pin integrated circuit voltage regulator that regulates output to a predetermined voltage.
